(19) United States
(12) Patent Application Publication
(10) Pub. No.: US 2011/0007037 A1
(43) Pub. Date: Jan. 13, 2011

(54) ELECTRONIC PEN AND ELECTRONIC PEN SYSTEM

(75) Inventor: Toshiyuki OGAWA, Fukuoka (JP)

Correspondence Address: GREENBLUM & BERNSTEIN, P.L.C., 1950 ROLAND CLARKE PLACE, RESTON, VA, 20191, US

(73) Assignee: PANASONIC CORPORATION, Osaka (JP)

(21) Appl. No.: 12/830,579

(22) Filed: Jul. 6, 2010

(30) Foreign Application Priority Data
Jul. 7, 2009 (JP) 2009-160347

(51) Int. Cl. G06F 3/033

(52) U.S. Cl. 345/179

(57) ABSTRACT

An electronic pen electronically drawing lines on a terminal apparatus comprises a display, a gap, and a conductive member. The display displays a property of the electronic pen, and is a piece of electronic paper and extending around an external periphery of the electronic pen. The gap is provided between both opposing ends of the display. The conductive member is positioned in the gap and is connected to the display to supply signals to the display.

### CROSS-REFERENCE TO RELATED APPLICATIONS

The present application claims priority under 35 U.S.C. §119 of Japanese Application No. 2009-160347, filed on Jul. 7, 2009, the disclosure of which is expressly incorporated by reference herein in its entirety.

### BACKGROUND OF THE INVENTION

1. Field of the Invention

The present invention relates to an electronic pen and an electronic pen system that allow handwritten input of characters and shapes into a tablet, and selection of information displayed on the tablet to be inputted into a higher-level device.

2. Description of Related Art

Conventional examples of input devices imitating a writing tool used on paper include an electronic pen that provides input on a tablet connected to a personal computer; or a stylus pen that provides input on a transparent touch panel of a display screen of a portable device. For example, a pen-shaped pointing device is disclosed that includes a display and a side surface switch, the display emitting color using a red LED, a green LED, and a blue LED. The device emits color on the display of the electronic pen using the color set on the electronic pen (see Related Art 1).

Further, as a sales assisting device, an electronic pen is disclosed that includes an input unit that selects and specifies line thickness for writing a letter with the electronic pen (see Related Art 2).

[Related Art 1] Japanese patent No. 3520823

[Related Art 2] Japanese laid-open patent application No. H6-110424

The above-described conventional structures have a display showing a property such as a color and a width of lines. However, since the display is a flat object, the display is located on the top end of the pen or a part of its side. So the display area is small, which makes it difficult for the user to view the display.

Further, when the electronic pen is turned off, the display shows nothing. Thus, it is impossible for the user to recognize the color, the width, etc. of lines when the pen is off.

### SUMMARY OF THE INVENTION

The present invention is provided to address the above-described problems. An advantage of the present invention is to provide an electronic pen and an electronic pen system that make it possible to easily recognize a property of the electronic pen such as color and thickness of lines, even when the power to the electronic pen is turned off.

In order to address the problems above, one aspect of the present embodiments provides an electronic pen electronically drawing lines on a terminal apparatus, the electronic pen comprising: a display that displays a property of the electronic pen, the display being a piece of electronic paper and extending around an external periphery of the electronic pen; a gap that is provided between both opposing ends of the display; and a conductive member that is positioned in the gap and is connected to the display to supply signals to the display.

Another aspect of the present embodiments provide an electronic pen system comprising: an electronic pen and a terminal apparatus on which the electronic pen electronically draws lines, wherein, the electronic pen comprises: a display that displays a property of the electronic pen, the display being a piece of electronic paper and extending around an external periphery of the electronic pen; a gap that is provided between both opposing ends of the display; and a conductive member that is positioned in the gap and is connected to the display to supply signals to the display.

According to the electronic pen and the electronic pen system of the present embodiments, the display is a piece of electronic paper which is flexible, so it can be extending around the external periphery of the electronic pen, all over except the gap in which the conductive member is located. Therefore, the display area is big and this makes it easy for the user to recognize the pen property such as color of lines. Furthermore, since the display is a piece of electronic paper, it can keep displaying the property of the pen even when the pen is turned off. Thus, the user can easily recognize the pen property even when the power to the electronic pen is turned off.

### BRIEF DESCRIPTION OF THE DRAWINGS

The present invention is further described in the detailed description which follows, in reference to the noted plurality of drawings by way of non-limiting examples of exemplary embodiments of the present invention, in which like reference numerals represent similar parts throughout the several views of the drawings, and wherein:

FIG. 1 is a schematic view of a system according to a first embodiment of the present invention;

FIG. 2 is a basic block diagram of an electronic pen system according to the first embodiment of the present invention;

FIGS. 3A-3C illustrate a basic configuration of the electronic pen according to the first embodiment of the present invention;

FIGS. 4A and 4B illustrate a configuration of a display of the electronic pen according to the first embodiment of the present invention;

FIG. 5 is an operational flowchart of the electronic pen system according to the first embodiment of the present invention;

FIG. 6 is an operational flowchart of the electronic pen system according to the first embodiment of the present invention;

FIGS. 7A and 7B illustrate a basic configuration of an electronic pen according to a second embodiment of the present invention;

FIGS. 8A and 8B are cross sectional views of a display of the electronic pen according to the second embodiment of the present invention;

FIG. 9 is an operational flowchart of the electronic pen system according to the second embodiment of the present invention;

FIGS. 10A and 10B illustrate a basic configuration of an electronic pen according to a third embodiment of the present invention;

FIGS. 11A and 11B are cross sectional views of a display of the electronic pen according to the third embodiment of the present invention;

FIGS. 12A through 12C illustrate a basic configuration of an electronic pen according to a fourth embodiment of the present invention;

FIGS. 13A and 13B illustrate a basic configuration of an electronic pen according to a fifth embodiment of the present invention;

FIG. 14 is a cross sectional view of a display of the electronic pen according to the fifth embodiment of the present invention;

FIGS. 15A-15C are schematic views of a clip portion and a gap portion of the electronic pen used in the fifth embodiment of the present invention;

FIGS. 16A and 16B are other schematic views of the clip portion and the gap portion of the electronic pen used in the fifth embodiment of the present invention; and

FIG. 17 is a cross sectional view of a pen point of the electronic pen used in the first through the fifth embodiments of the present invention.

### DETAILED DESCRIPTION OF THE INVENTION

The particulars shown herein are by way of example and for purposes of illustrative discussion of the embodiments of the present invention only and are presented in the cause of providing what is believed to be the most useful and readily understood description of the principles and conceptual aspects of the present invention. In this regard, no attempt is made to show structural details of the present invention in more detail than is necessary for the fundamental understanding of the present invention, the description is taken with the drawings making apparent to those skilled in the art how the forms of the present invention may be embodied in practice.

Specific illustrations are given as follows using embodiments of the present invention.

### First Embodiment

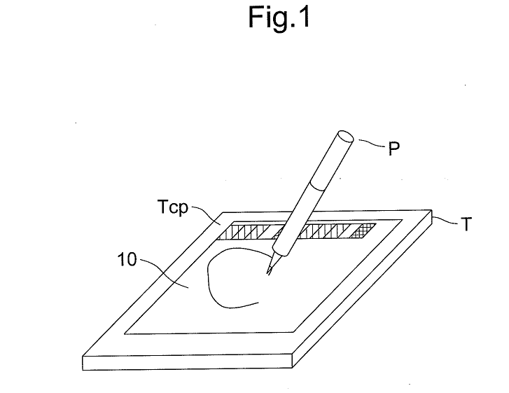

FIGS. 1 though 6 are used to illustrate the first embodiment of the present invention. FIG. 1 is a schematic view of a system according to the first embodiment of the present invention. An electronic pen system is configured with an electronic pen P and a terminal apparatus T, and a user electronically draws lines on a display 10 of the terminal apparatus T with the electronic pen P. The display 10 of the terminal apparatus T displays a color palette Tcp as a menu to set up a line density.

In the first embodiment, examples are given only to specify density (i.e. gray scale) as a pen property. However, other pen property settings such as color, line width, line type (e.g., solid, broken, double lines) and the like may be included in the menu to be displayed together on the display 10 of the terminal in the similar manner. The line written by the electronic pen P appears on the display 10 with the set pen property.

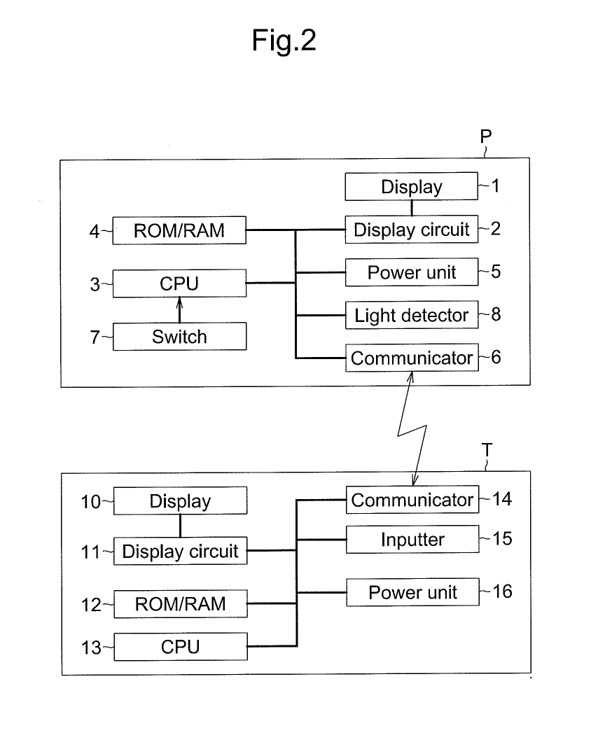

FIG. 2 is a basic block diagram of the electronic pen system according to the first embodiment of the present invention. The electronic pen P includes a display 1 (to display the line density), a display circuit 2, a CPU 3, a ROM/RAM 4 (memory), a power unit 5, a communicator 6 (to communicate with the terminal apparatus T), a switch 7 (to turn on/off the power of the electronic pen P and to set the pen property), and a light detector 8 (to detect light at the pen point).

In FIG. 2, the display circuit 2 is a circuit that supplies a voltage to a plurality of electrodes of the display 1. The display circuit 2 performs gradation control of reflected light amounts supplied from one display layer, by controlling a voltage value applied to the electrodes and wave patterns, thereby changing the ratio of scattering and transmission in display cells.

The CPU 3 controls the circuit of the electronic pen P using programs and data stored in the ROM/RAM 4 (memory).

The power unit 5 is energy to operate the circuit of the electronic pen P, and is configured with a battery or a high-capacity capacitor. The power unit 5 may be configured with a power receiving circuit and a capacitor circuit (not shown in the drawing) configured with a coil, in order to receive energy in a non-contact manner through electromagnetic induction of the electromagnetic wave generated by the terminal apparatus T.

The communicator 6 is a wireless communication circuit that performs two-way transmission and reception of data between the electronic pen P and the terminal apparatus T. In this example, the wireless communication method may utilize 802.11b/g, which is a known wireless LAN, or a contiguous communication method such as the Bluetooth or RFID.

The electronic pen P has one or more switches 7 that input information of the electronic pen P, control turning on/off of the pen; set the pen property, detect pressing of the pen point, and the like.

The light detector 8 detects light when the light radiating from the pen point to outside reflects externally and radiates back into the pen point.

The terminal apparatus T is an apparatus equivalent to a personal computer such as a tablet PC, a PDA and a smart phone, and includes a terminal display 10, a display circuit 11, a ROM/RAM 12 (memory), a CPU 13, a communicator 14 (to communicate with the electronic pen P), an inputter 15 (to detect and input locations of the electronic pen P), and a power unit 16. Further, the terminal apparatus T includes a pen property setter (not shown in the drawing). The inputter 15 is configured with a touch panel having a resistance film, a tablet that detects, through the electromagnetic induction, a location of the electronic pen, or the like.

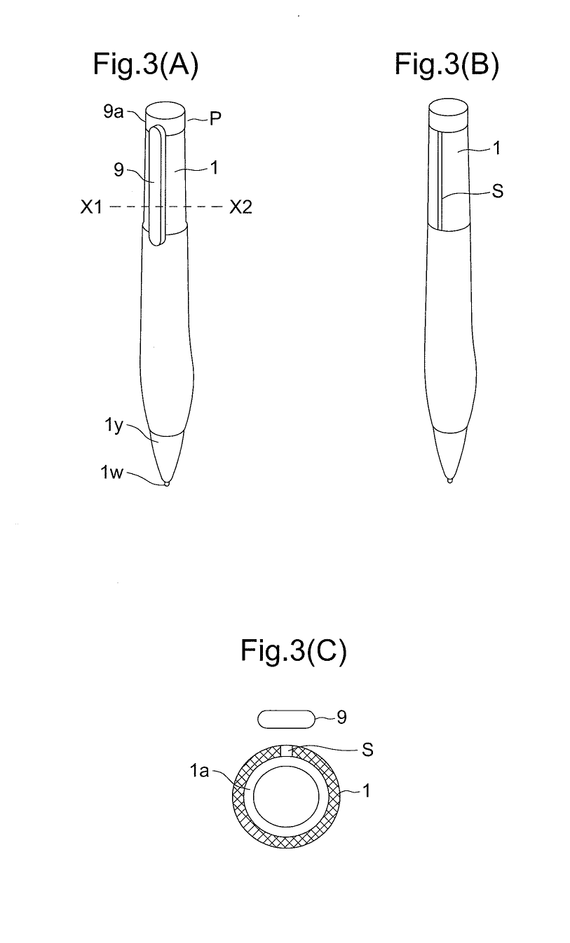

FIGS. 3A-3C illustrate a basic configuration of the electronic pen according to the first embodiment of the present invention. FIG. 3A is a schematic view of the electronic pen. The electronic pen P according to the first embodiment includes the display 1, a clip 9, a protective member 9a, a pen point holder 1y, and a pen point 1w.

FIG. 3B is a schematic view of the electronic pen P prior to having the clip 9 attached. The display 1 extends around the electronic pen P. The display 1 is a piece of electronic paper. Since electronic paper is flexible, it can be easily wound around the electronic pen P and its electricity consumption is low. The FIG. 3B also shows a gap S having both end surfaces of the display 1 opposing to each other.

FIG. 3C is a cross-sectional drawing of the electronic pen P taken along broken line X1-X2 of FIG. 3A. An external peripheral surface of an electronic pen case 1a is surrounded by the display 1. The gap S is shown between the both opposing ends of the display 1, sandwiched by the clip 9 and the electronic pen case 1a.

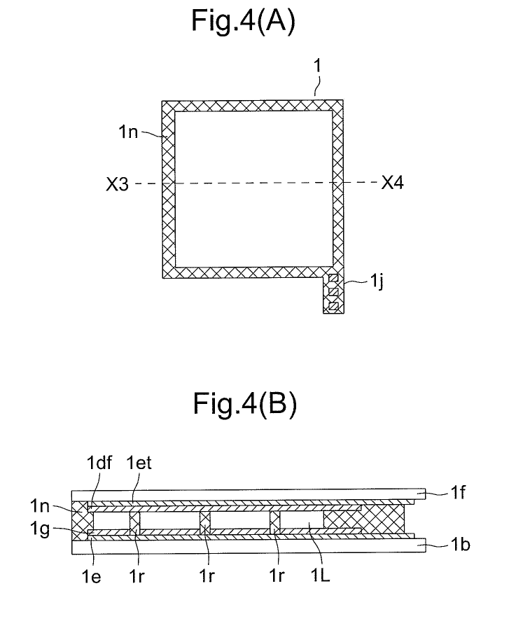

FIGS. 4A and 4B illustrate a configuration of the display of the electronic pen according to the first embodiment of the present invention. FIG. 4A illustrates the display 1 prior to being wrapped around the electronic pen case 1a. FIG. 4B illustrates a cross sectional drawing of the display 1 taken along broken line X3-X4 of FIG. 4A.

As shown in FIG. 4A, there is only one display layer in the first embodiment. The electrodes of the display 1 are connected to a conductive member, which extends to a connector 1j to be connected to the display circuit housed within the electronic pen case. The connector 1j is positioned in the gap S.

FIG. 4B is used to illustrate detailed configuration of the display 1 according to the first embodiment 1. The display 1 is a piece of liquid crystal-type electronic paper, and includes a transparent film 1f having a transparent electrode 1et; a base film 1b having a light absorbing layer 1g and an electrode 1e; a spacer member 1r; and a polarizing film 1df. The display 1 is surrounded and sealed to form a cell, with a sealing material 1n, such as a thermoplastic resin, thermosetting resin, light curing resin, or the like. A liquid crystal material 1L is injected into the cell, the material having a display retaining property and is configured with a coloring agent, chiral material, cholesteric liquid crystals, and the like. Finally, the injection opening is sealed to form a display cell.

The display cell utilizes characteristics of liquid crystal material that scatters or transmits external light depending on the amount of voltage applied between the transparent electrode 1et and the electrode 1e. Therefore, when the display cell scatters the external light, a color is displayed. When the external light transmits through the display cell and absorbed by the light absorbing layer 1g, black is displayed.

When a base film portion having the base film 1b provided with the electrode 1e, the light absorbing layer 1g, and the spacer member 1r, is attached to a surface layer film portion having the transparent film 1f provided with the transparent electrode 1et and the polarizing film 1df, both of the films are bonded together by closely attaching each other with a roller used in a manufacturing process, thereby providing a curvature in the display 1.

The light absorbing layer 1g is configured by attaching a colored film on the surface of the electrode 1e, or by applying a colored paint on the surface of the electrode 1e. In addition, it is preferable to use a colored (more preferably, black) conductive material for the electrode 1e.

In the connector 1j, the transparent film 1f is made shorter than the base film 1b. The electrode 1e exposed at the end portion of the base film 1b undergoes a patterning process to configure two connecting terminals. One of the connecting terminals is a line-shaped electrode, and is connected to the electrode 1e of the base film 1b, which is substantially the same size as the display 1. The other connecting terminal is a line-shaped electrode divided from a portion of the electrode 1e of the base film 1b through the patterning process. The sealing material 1n around this portion is masked to prevent its application, so that the terminal is connected to the transparent electrode 1et of the transparent film 1f.

A conductive member 1p that is thermally fused for increasing the electrical connectivity is applied between the line-shaped electrode 1e and the transparent electrode 1et. Further, it is preferable for the connecting terminal to be plated with a metal material, such as gold, so that the contact resistance during the connector connection is reduced, thereby increasing the connection reliability.

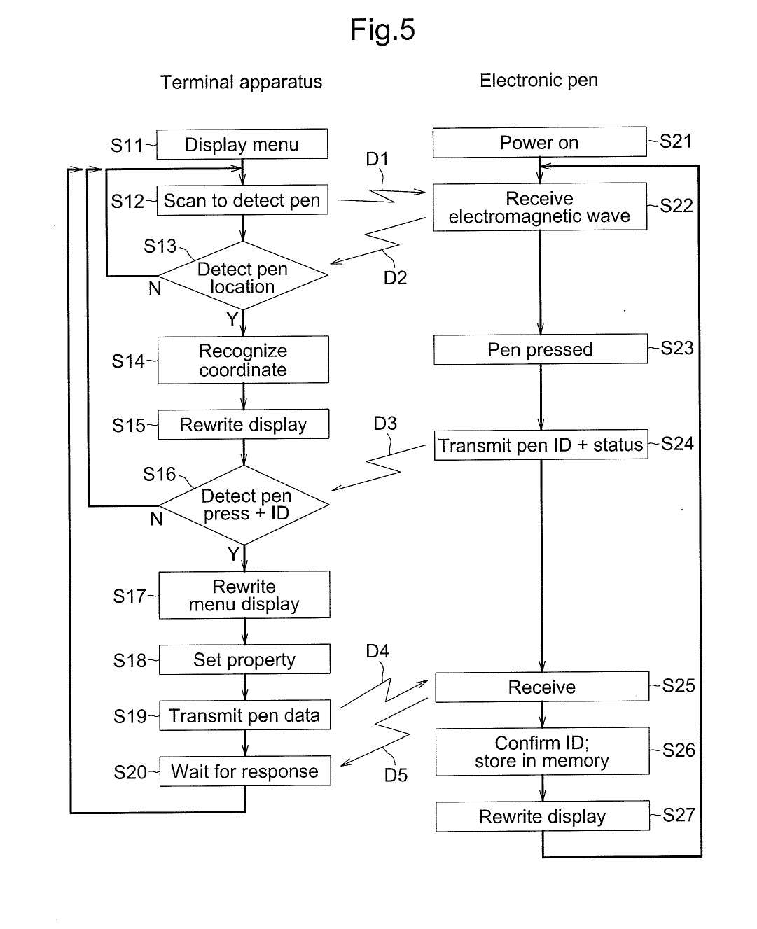

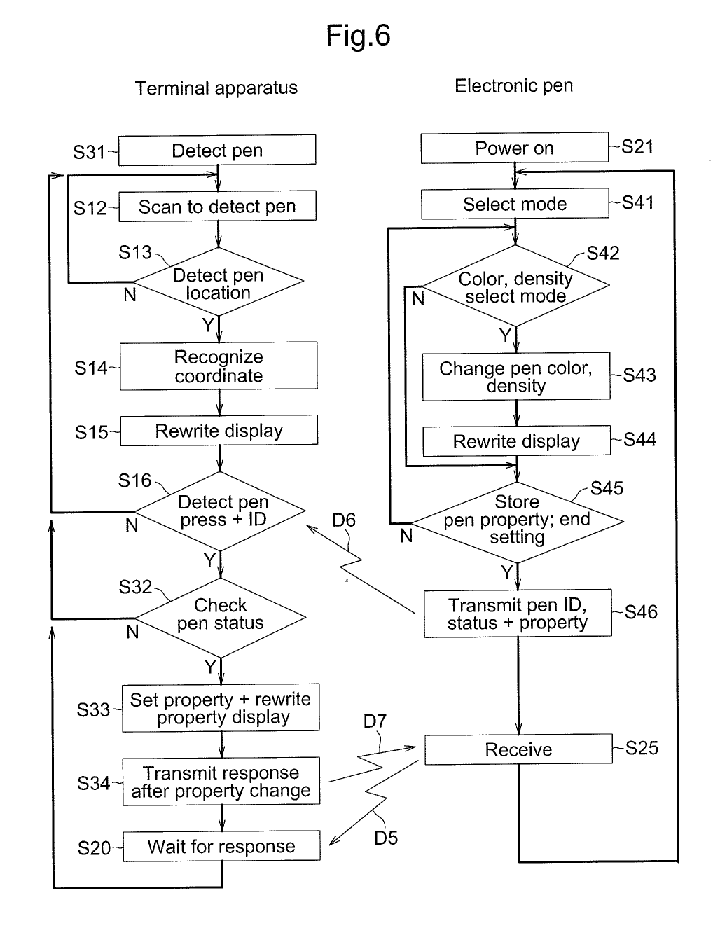

FIGS. 5 and 6 are used to illustrate an operation flow of the electronic pen system according to the first embodiment of the present invention. In the first embodiment, a color drawn by the electronic pen P is one color, since there is one display layer in the display 1. FIG. 5 is used to illustrate selecting and setting of color density from a menu displayed on the terminal apparatus, while FIG. 6 is used to illustrate selecting and setting of color density by pressing the switch 7 connected to the pen point 1w. Hereafter, a state where the switch 7 is pressed for 0.5 seconds or less to be turned on is referred to as “knocking,” while a state where the switch is pressed for 2 seconds or longer to be turned on is referred to as “holding.”

In FIG. 5, the terminal apparatus T displays an operation menu on the display 10 of the terminal (step S11). For example, the color palette Tcp for setting the color density of the pen, as one property of the pen, is displayed.

Subsequently, the inputter 15 (input circuit) is driven to perform a pen detection scan, in order to detect a location of the electronic pen P (step S12). For example, an alternating current is supplied to a coil located to surround the terminal display 10 and an electromagnetic wave D1 is output.

Meanwhile, the electronic pen is first turned on (step S21), and a circuit configured with a coil and a capacitor internally housed in the power unit 5 of the electronic pen receives the electromagnetic wave from the inputter 15 of the terminal apparatus T (step S22).

The electric power received by the coil at this time may be charged in a battery of the power unit 5 and utilized as energy for the electronic pen. Further, a signal receiving the electromagnetic wave D1 causes the switch control of the connection of another coil and a capacitor connected to the coil, and an electromagnetic wave D2 is output from the coil to the terminal apparatus T.

The inputter 15 of the terminal apparatus T includes wirings (not shown in the drawing) for location detection, the wirings having a plurality of loop coils aligned in matrix directions. Each of the loop coil wirings is connected to the reception circuit for the scan, and detects the pen location from a level of a signal generated by the electromagnetic wave D2 (step S13). When the pen location cannot be detected at step S13, the control returns to step S12 for the pen detection scan in order to repeat the detection of the pen location.

From the relation between the pen location and the menu display location, a coordinate is recognized (step S14). In a location corresponding to the electronic pen P and the terminal display 10, a cursor indicating the location of the electronic pen P is displayed by controlling the display circuit 11 (step S15). When the user touches the display 10 of the terminal apparatus T via the electronic pen P, a switch connecting from the pen point is turned on, and it is recognized that the pen point is pressed (step S23). When the pen point is pressed, information D3 that includes a unique ID number of the electronic pen internally stored in the ROM/RAM 4 (hereafter referred to as pen ID) and a status of the pen press is transmitted to the terminal apparatus T from the communicator 6 (communication circuit) (step S24).

The communicator 14 of the terminal apparatus T receives the pressing of the electronic pen and the pen ID data (step S16). Then, a menu display corresponding to the location is rewritten when the pen pressing is performed on the menu display that changes the density as the pen property (step S17). For example, when changing the pen color density in the first embodiment, and using the color palette Tcp having a density area of different brightness levels, the electronic pen is knocked and pressed down within the density area having a rectangular shape in the color palette Tcp. Then, an outer frame of the rectangular shape is changed to a thicker frame, and the area indicating the pen color density is changed to reflect the same color density as the selected area.

In step S16, when the pen pressing and the pen ID cannot be detected, the control returns to the pen detection scanning of step S12 to repeat the pen location detection.

The terminal apparatus T changes the property setting for the pen corresponding to the pen ID set by the user (step S18). Subsequently, data D4 including the pen property data and the pen ID is transmitted from the communicator 14 to the electronic pen P (step S19), to wait for a response from the electronic pen P (step S20). When the response is received, the control returns to step S12.

When the communicator 6 of the electronic pen P receives the pen property data and the pen ID, the communicator 6 transmits the pen ID and a response signal D5 to the terminal apparatus T (step S25). When an ID unique to the electronic pen and the received pen ID match, the pen property data is stored in the ROM/RAM 4 (step S26). Further, the display circuit 2 is controlled to rewrite and change the display 1 into the corresponding density of the pen property (step S27).

Next, FIG. 6 is used to illustrate a method to have the color density selected by the electronic pen reflected on the terminal apparatus T. In FIG. 6, the process elements similar to FIG. 5 are provided with the same numerical references, and the illustration thereof is omitted.

The terminal apparatus T repeats processes of detecting the electronic pen P (step S31); scanning for pen detection by driving the inputter 15 (input circuit) for detecting the location of the electronic pen P (step S12); detecting the location of the pen (step S13); recognizing a coordinate (step S14); rewriting the display (step S15); and detecting the pen pressing and ID (step S16).

At this point, the user operates the switch 7 of the electronic pen P, and selects a mode that changes the density of the pen, as a mode selection (step S41). For example, the switch 7 is pressed twice continuously within one second to turn on and off the switch 7 (hereafter referred to as double knocking), in order to change the state from a using state to a mode selection state (step S41).

In this example, when the selection mode is in the density selection mode (step S42), repeating a single on/off operation afterward (hereafter referred to as knocking) moves up one level per knocking, of the density level from level 0 to level 7, when there are 8 levels of gradation (step S43). The display circuit 2 is controlled according to the changed value and the display 1 is rewritten (step S44).

Next, when the CPU 3 detects the double knocking operation of the switch 7, the CPU 3 stores the selected density level as a pen property value in the ROM/RAM 4, sets a status flag in the ROM/RAM 4 indicating that the pen property has been changed, and checks whether the setting mode of the pen property is completed (step S45). When the display 10 of the terminal apparatus T is touched by the electronic pen P, the electronic pen P detects the pen pressing by the switch connected to the pen point. Since the pen property has been changed, the communicator 6 transmits the pen ID, the status flag, and data D6 indicating the pen property (density) (step S46).

When the communicator 14 of the terminal apparatus T receives the pressing of the pen point of the electronic pen P, the pen ID, and the pen property data (step S16), the terminal apparatus T confirms the status flag of the pen. When the pen property change is recognized (step S32), the terminal apparatus T changes the pen property corresponding to the pen ID to the received data value, and rewrites the property display of the display 10 showing the pen property (step S33). For example, when the pen color density is changed from density level 0 to density level 4, the rectangular area showing the property display is changed from density level 0 to the selected density level 4, similar to the density of the display 1 of the electronic pen P.

Since the terminal apparatus T has completed the pen property change, a response signal D7 indicating the completion of the property change is transmitted from the communicator 14 (step S34). Succeedingly, the terminal apparatus T waits for the response signal D5 from the electronic pen P (step S20). When the signal is received, the control returns to step S12.

Upon receiving the response signal D7 from the terminal apparatus T, the communicator 6 of the electronic pen P transmits, to the terminal apparatus T, the response signal D5 (step S25), which completes the pen property change process.

When the user switches the operation of the terminal apparatus T to the pen input mode, the terminal apparatus T draws a line having density level 4 on the display 10, according to the motion and input location of the electronic pen P. For example, when a pen 1 having V1 as its pen ID is set to gray color with density level 4 and a pen 2 having V2 as its pen ID is set to black color with density level 7, the line drawn on the display 10 by the pen 1 is written in gray, and the line drawn on the display 10 by the pen 2 is written in black.

As for the line thickness and type used herein, the pen property set in the terminal apparatus T according to the detected electronic pen ID is applied.

In the above explanation, an example where the pen density is displayed in the display 1 of the electronic pen P is used. Since the display 1 is electronic paper, it can keep displaying the current density level even when the power is turned off. However, in order to make it possible for the user to determine whether the power is on or off, the density level of the display 1 may be changed to density level 0, i.e., white color, when the power is turned off. In such a case, when the power is on, the density level may be set to density level 7, i.e., black color, or to a level that is previously set (e.g., density level 4, i.e., gray color), in order to indicate that the power of the electronic pen P is turned on.

In the above example, liquid crystal-type electronic paper is used as the display 1. However, a similar effect can be achieved with other types of electronic paper. Electrophoretic-type electronic paper such as an electronic paper device by EINK, which uses a transparent microcapsule containing electrophoretic colored electronic ink and a liquid dispersing medium can be used. In this case, a plurality of the above-described microcapsules are aligned to configure a display layer. One display layer is configured by one set of electrodes, which form one display cell. Also, Micro-encapsulation (Gyricon)-type or electrowetting-type electronic paper can be used, too.

As described above, a display provided on the external periphery surface of the electronic pen displays, for the user, black and white display switching, indicating the power being turned off/on, and color density set as the pen property.

Further, since the pen property setting for the electronic pen system and the pen input can be easily made, the pen property set for one electronic pen is reflected on each terminal apparatus, when the pen used by one user is used to input into a plurality of terminal apparatuses. Therefore, it is possible to provide excellent usability.

### Second Embodiment

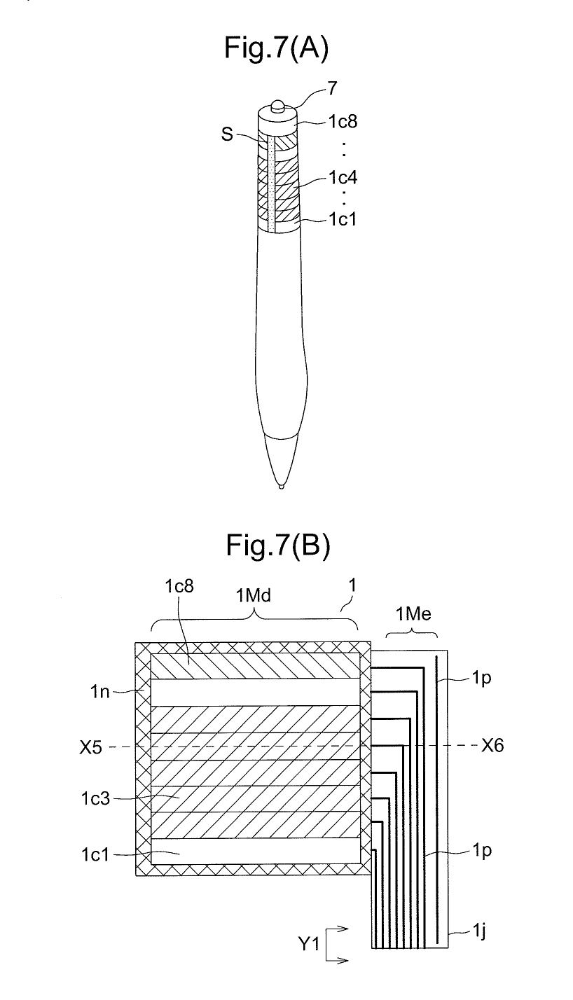

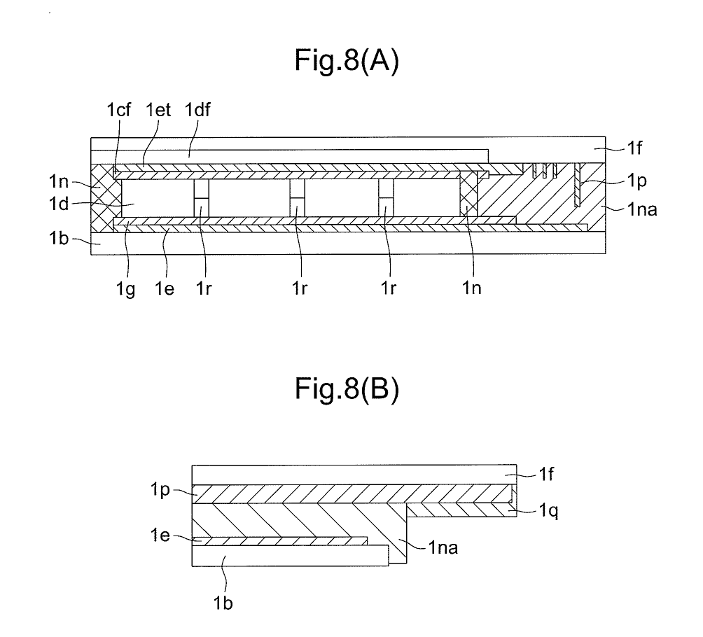

FIGS. 7A, 7B, 8A, and 8B are used to illustrate a second embodiment of the present invention. FIGS. 7A and 7B illustrate a basic configuration of an electronic pen according to the second embodiment of the present invention. FIGS. 8A and 8B are cross sectional views of a display of the electronic pen according to the second embodiment of the present invention. The basic block diagram of the second embodiment is the same as the first embodiment, which is shown in FIG. 2. Structural elements similar to the first embodiment are provided with the identical numerical references, and illustrations thereof are omitted.

FIGS. 7A and 7B illustrate the display 1 of the electronic pen according to the second embodiment of the present invention. FIG. 8A is a cross sectional view of the display 1 of according to the second embodiment of the present invention, taken along a broken line X5-X6 (of FIG. 7B), while FIG. 8B is fragmentary view of an arrowed portion Y1 (of FIG. 7B).

In FIG. 7A, the display 1 includes 8 separate types of display layers 1c1-1c8, which are aligned around the electronic pen P. An operation section of the switch 7 is provided in an upper end portion of the electronic pen P. The clip 9 is omitted from this drawing.

In FIG. 7B, the display 1 is configured with a display area 1Md, which includes a plurality of display cells, and a wiring area 1Me, which connects to a display circuit 2. The wiring area 1Me is in the connector 1j and is provided in the location of the gap S.

In FIG. 8A, the display 1 is configured with a transparent film 1f having a transparent electrode 1et, a color filter 1cf, and a polarizing film 1f; a base film 1b having a light absorbing layer 1g and an electrode 1e; and a spacer member 1r. A cell is formed by sealing the periphery of the film, and the sealed cell is injected with a liquid crystal material 1d. The injection opening is sealed to form a display cell.

The display surface of the display 1 is configured with the transparent film 1f, which is bonded by the polarizing film 1df. The transparent film 1f includes the color filter 1cf for the display color and the transparent electrode 1et, both of which are layered thereon. In this example, the electrode 1e is one common electrode having substantially the same size as the display area. Each transparent electrode 1et is provided for a color filter. The transparent electrodes 1et are drive electrodes to control each of the display layers 1c1-1c8.

The rear surface of the display 1 is configured with a base film 1b, which serves as a base board. The base film 1b includes the electrode 1e, and supplies a voltage between the transparent electrode 1et and the electrode 1e, in order to apply electric field to the liquid crystals within the display cell. It is preferable that surface of the electrode 1e is made of a black conductive material.

The transparent film 1f having the layered color filter 1cf and the transparent electrode 1et, is provided opposing the base film 1b having the electrode 1e, maintaining an equal distance therebetween by the spacer member 1r. The liquid crystal material 1d is filled into the display cell space, and the periphery of the display is sealed by the sealing material 1n.

By utilizing its characteristics that scatters or transmits external light, the display cell displays color of the color filter 1cf when scattering the external light, and displays black when the external light is transmitted through the display cell and absorbed by the light absorbing layer 1g.

FIG. 7A shows the display 1 having a plurality of display cells as described above. In this example, 9 types of basic colors are shown in total: 8 types being displayed by the color filters: the display layer 1c1 for red; 1c2 for orange; 1c3 for yellow; 1c4 for bright green; 1c5 for green; 1c6 for blue; 1c7 for purple; and 1c8 for white; and black/white. In addition, by changing voltage values and patterns to be applied to the driving electrode, the reflected light intensity may be adjusted for each color, thereby changing the color density.

For example, when the reflected light is minimized during the transmission state of the display cell, a voltage value of 5V is applied to the driving electrode with a pulse every 100μ second. The liquid crystal material 1d moves reacting to the applied electric field. Therefore it is possible to move more molecule level liquid crystals into reflective state in proportion to an increased number of applied pulses.

Further, when the voltage applied to the driving electrode is regulated from 1V to 24V in phases for 10 m second per application, the reflective light intensity may be adjusted.

In this example, the electrode 1e is connected to a wiring pattern on the surface side through the conductive member 1p of the wiring area 1Me. The plurality of the driving electrodes and the electrode 1e are pulled out to the connector 1j by the wiring pattern of the wiring area 1Me. The wiring pattern is configured by maintaining the wiring portion from the transparent electrode 1et of the transparent film 1f, but removing other unnecessary portions.

FIG. 8B is a fragmentary view of an arrowed portion Y1, of the wiring area 1Me of the display 1 in FIG. 7B. In the wiring area 1Me, the transparent film 1f is bonded to the base film 1b by sandwiching an insulation member 1na therebetween, the insulation member 1na insulating the driving electrode and the common electrode. Further, the connector 1j has a shorter base film than the film of the display surface, in order to expose the wiring pattern. The end surface of the wiring pattern is metal-plated to configure a plated portion 1q. The plated portion 1q of the connector 1j of the wiring area is connected to the display circuit 2, via a connector (not shown in the drawing), internally attached to the electronic pen case 1a.

The display circuit 2 supplies a voltage between the plurality of transparent electrodes let and the electrode 1e of the display 1. The display circuit 2 has independent outputs by the number of colors of the display layers. The switch 7 detects on/off of the operator of the switch 7 connected to the CPU 3 and provided in the upper end portion of the electronic pen. According to the operation of the switch 7, the CPU 3 generates selection information of the display layer to be displayed on display 1. The CPU 3 controls the display circuit 2.

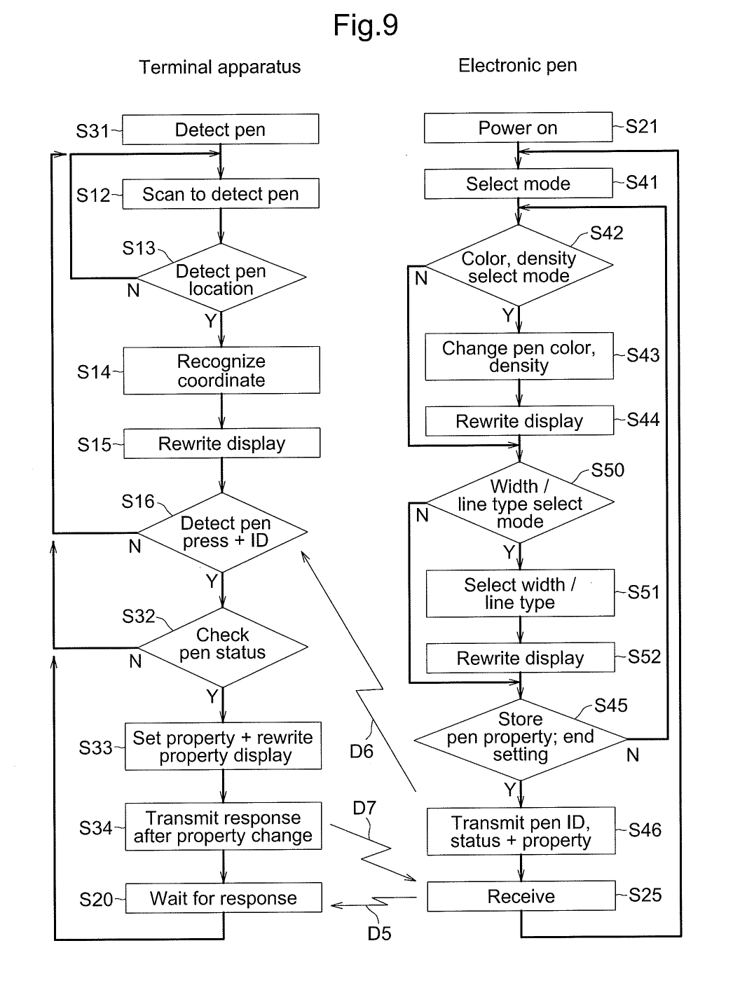

FIG. 9 is used to illustrate an operational flow of the electronic pen system according to the second embodiment of the present invention. Since, in the second embodiment, a plurality of colors are provided in the display layers of the display 1, the plurality of colors are available to be drawn by the electronic pen P. In the following explanation, the switch 7 is operated to select and set the color and line type in the second embodiment. In FIG. 9, the process elements similar to FIG. 6 are provided with the same numerical references, and the illustration thereof is omitted.

The power of the electronic pen P in the second embodiment is turned on/off by operating the switch 7 provided in the upper end portion of the pen. The input pattern and the number of the input on the switch 7 changes the pen property setting of the electronic pen, which includes color (including density), thickness, and line type. The electronic pen P turns on/off the power by detecting holding of the switch 7. A continuous knocking is detected as double-knocking. When the switch 7 is double-knocked when the power is on, the mode selection state is started.

The pen property of the electronic pen P includes color/density selection and thickness/line type selection. By double-knocking the switch 7 of the electronic pen P, the mode selection state is started in order to change the operation of the electronic pen (step S41), and selection is made to change the pen property (color/density and thickness/line type) of the electronic pen P. For example, double-knocking of the pen starts the color selection mode, while when double-knocking is repeated, thickness/line type selection mode can be started as illustrated in the following.

For example, when setting the color, the mode selection is made to select color/density. When the user knocks the switch 7 by viewing the display 1 of the electronic pen P, a desired color can be selected.

First, when the color/density selection mode is selected (step S42), a pen color is selected by knocking the switch 7 (step S43). In addition, the display 1 is rewritten to change the pen color to reflect the selected color, by controlling the display circuit 2 (step S44). Each time the switch 7 is knocked, the corresponding display layer of the display 1 is controlled to change the display layer of the reflective light, from red; orange; yellow; bright green; green; blue; purple; and to white, for example.

The display layer of the color not selected at this time is kept at the transmission mode having no reflective light, and the display layer of the selected color is displayed to the selected density level. The display layer 1c8 for white/black displays white color when the pen density is monochrome and when the power is turned off. When the color selection is completed, the switch is double-knocked to select the density. The density selection is the same as the above-description, therefore the illustration thereof is omitted.

Next, the switch is double-knocked to start the thickness/line type selection mode (step S50). First, the thickness selection mode is started for selecting the thickness (step S51). Each knocking will change the thickness level in phases from 1→2→3→4→5. At this time, the thickness change can be reflected on the display of the display layer 1c8 for black/white color, as an indication for the user. For example, when the thickness level is the lowest, the density level is changed to 1, and when the thickness level is the highest, the density level is changed to 7 for the display (step S52).

When the switch is double-knocked, the line type selection mode is started, where the knocking operation selects the line type (step S51). For example, each knocking changes the line type from solid line; broken line; 1 dot broken line; double line; and the like.

A portion of the surface of the display layer may be printed with line type symbols (not shown in the drawing), to temporarily change the display layer 1c1-1c7 corresponding to the line type as an indication (step S52). When the switch is double knocked twice to complete the pen property setting, the pen property after the setting change is stored in the ROM/RAM 4 (step S45), and data D6 including the status flag indicating the changed property of the electronic pen and the pen ID is transmitted by the communicator 6 to the terminal apparatus T (step S46). When the switch is double knocked only once after the line type setting, the control moves back to step S42 for the color/density selection mode again.

When the terminal apparatus T receives the data D6 at step S16 and verifies the change of the pen status (step S32), the terminal apparatus T sets the pen property corresponding to the pen ID, rewrites the display (step S33), and transmits, to the electronic pen, a response signal D7 indicating the completion of the pen property change (step S34). Then, the terminal apparatus T waits for the response signal D5 from the electronic pen (step S20). When receiving the response signal, the control returns to step S12.

When the electronic pen receives the response signal D7 from the terminal apparatus T, the communicator 6 transmits the response signal D5 to the terminal apparatus T (step S25).

For example, when the red color is displayed on the display 1 of the electronic pen and the color in the pen property is changed to red, the pen property of the terminal apparatus T is changed by touching the display 10. After this, it is possible to input in the terminal apparatus T using a red line through the electronic pen P.

As described above, according to the second embodiment of the present invention, the display provided on the external periphery surface of the electronic pen is used to indicate a plurality of colors set for the pen property, and the electronic pen is used to change the color/density and thickness/line type.

In the second embodiment, the display is configured with 8 types of display layers. However, the display may be configured with any desired plurality of display layers.

### Third Embodiment

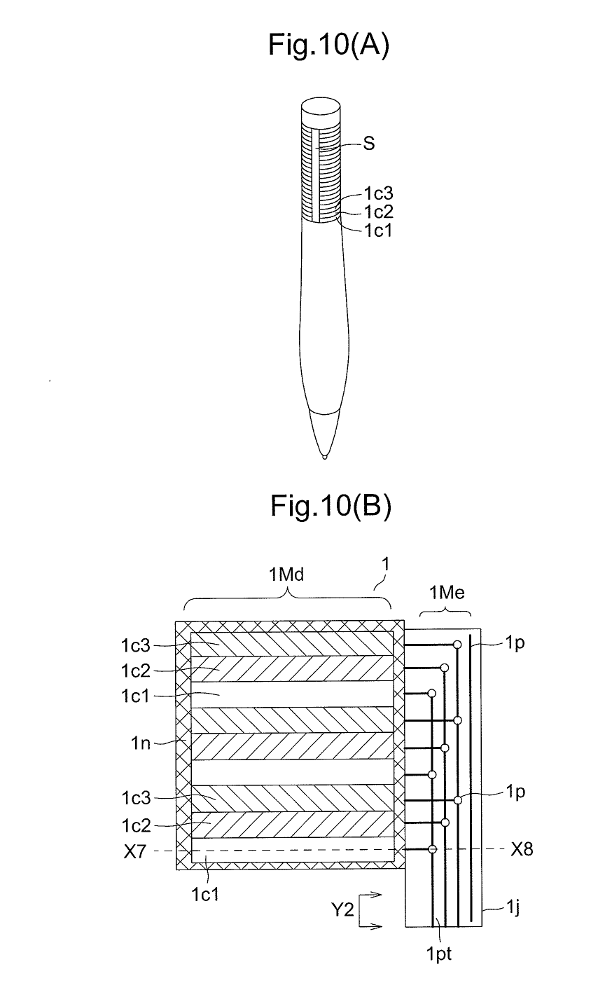

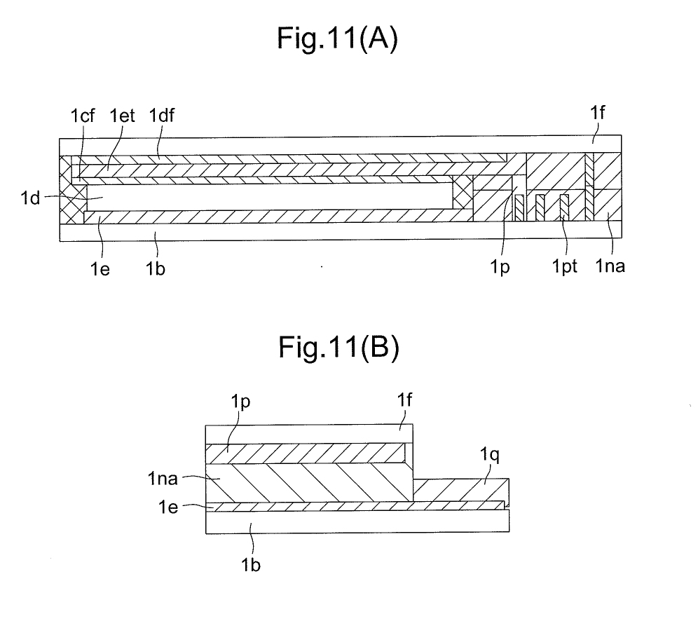

FIGS. 10A, 10B, 11A and 11B are used to illustrate a third embodiment of the present invention. FIGS. 10A and 10B illustrate a basic configuration of an electronic pen according to the third embodiment of the present invention. FIGS. 11A and 11B are cross sectional views of a display of the electronic pen according to the third embodiment of the present invention. The basic block diagram of the third embodiment is the same as the first embodiment, which is shown in FIG. 2. In FIGS. 10A and 10B, structural elements similar to the first and the second embodiments are provided with the identical numerical references, and illustrations thereof are omitted.

FIGS. 10A and 10B illustrate the display 1 according to the third embodiment of the present invention. FIG. 11A is a cross sectional view of the display 1, taken along a broken line X7-X8 (of FIG. 10B), while FIG. 11B is fragmentary view of an arrowed portion Y2 (of FIG. 10B).

In FIG. 10B, the display 1 is configured with a display area 1Md, which includes a plurality of display cells, and a wiring area 1Me, which connects to a display circuit 2. The wiring area 1Me is provided in the location of the gap S.

As shown in FIGS. 10A and 10B, the display 1 includes a plurality of display layers 1c1-1cn. The color filters of the display layers have the 3 basic colors (represented by R/red; G/green; and B/blue), or other plurality of basic colors (for example, C/cyan; M/magenta; Y/yellow; and K/black). Further, the display layers 1c1-1cn have a thin display width for each color in relation to the external periphery of the electronic pen, and the plurality of the display layers are around the electronic pen by repeating the display layers of the basic colors RGB or CMYK.

As shown in the cross sectional view of the display 1 in FIG. 11A, the transparent electrode 1et is divided into a number of display layers by corresponding to the location of each color filter. In the wiring area 1Me, the conductive member 1p connects each of the transparent electrodes 1et corresponding to the same color filter to the wiring pattern 1pt provided on the base film 1b.

In the display 1, the transparent electrode 1et is provided for each color filter 1cf for each display layer, which configures a driving electrode. The wiring area 1Me is configured with an insulating film processed with through holes, the transparent film 1f, and the base film 1b. The through holes are filled with the conductive member 1p, to which the film is glued. Further, a thermal pressurizing process is performed on the wiring area. The wiring pattern for each driving electrode is connected, through the conductive member 1p, to the wiring pattern on the base film 1b, which serves as a base board in the rear surface.

Additionally, it is preferable that the display 1 include a separation wall configured with a resin or a sealing material, in the gaps between the adjacent display layers.

In the fragmentary view of the wiring area 1Me of the display 1 in FIG. 11B, the connector 1j that connects the wiring area 1Me and the display circuit 2 has a longer base film 1b than the film of the display surface, in order to expose the wiring pattern. The end surface of the wiring pattern is metal-plated to configure the plated portion 1q. The plated portion 1q of the connector 1j is connected to the display circuit 2, via a connector (not shown in the drawing).

The display circuit 2 supplies a voltage between the plurality of transparent electrodes 1et of the display 1. The display circuit has independent outputs by the number of the color filter colors of the display layers.

According to the third embodiment of the present invention, the display of the electronic pen controls gradation of the basic colors for display. Therefore, various colors can be viewed from human eyes as an indication to the user. For example, when 3 color filters having 3 types (R, G, and B), and when each color is controlled into 8 gradations, 512 different colors can be displayed.

Further, since each display layer has a thin width and is concentrically aligned, it is possible to improve the inconvenience of changing colors by the different viewing angle.

In the third embodiment, a thinly elongated rectangle shape was used as a display cell for the display layer. However, the same effect can be achieved when a curbed wavy shape or shape having a varied width is used.

In the third embodiment, operations for the color and line type selections for the electronic pen are the same as the operation flow shown in FIG. 9 of the second embodiment.

### Fourth Embodiment

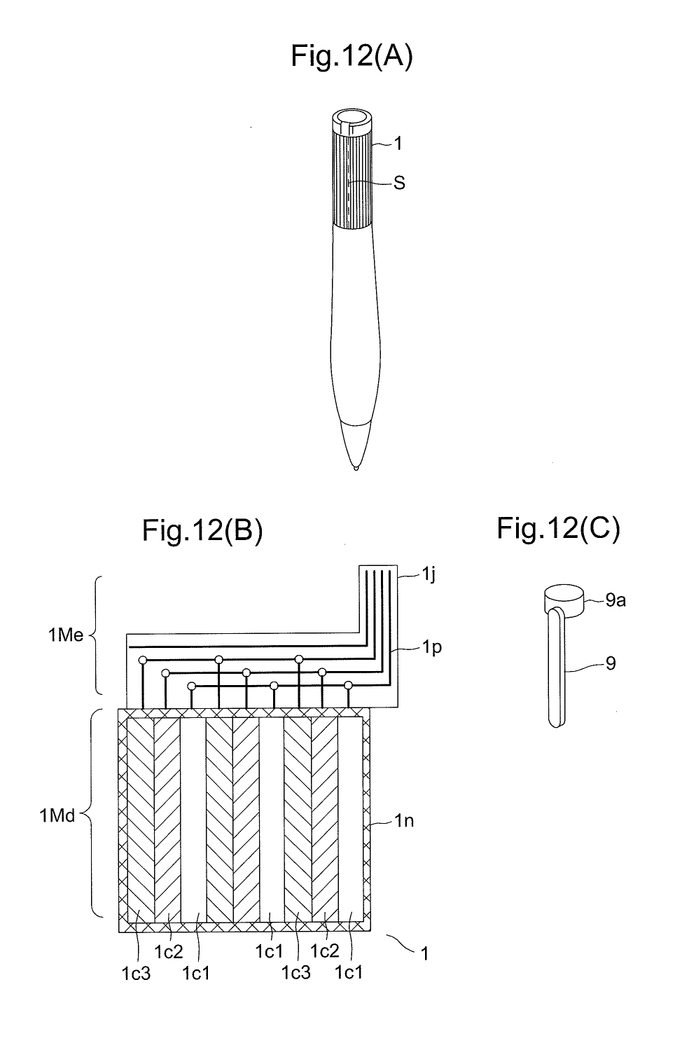

FIGS. 12A-12C are used to illustrate a fourth embodiment of the present invention. FIGS. 12A through 12C illustrate a basic configuration of an electronic pen according to the fourth embodiment of the present invention. The basic block diagram of the fourth embodiment is the same as the first embodiment, which is shown in FIG. 2. In FIG. 12, structural elements similar to the first to the third embodiments are provided with the identical numerical references, and illustrations thereof are omitted.

FIGS. 12A and 12B illustrate the display 1 of the electronic pen according to the fourth embodiment of the present invention. FIG. 12C is a schematic view of a clip member.

As shown in FIG. 12B, the display 1 is configured with a display area 1Md, which includes a plurality of display cells, and a wiring area 1Me, which connects to a display circuit 2. The wiring area 1Me is provided in the upper end portion of the electronic pen P.

As shown in FIG. 12B, the display 1 includes a plurality of display layers 1c1-1cn. The color filters of the display layers have the 3 basic colors (represented by R/red; G/green; and B/blue), or other plurality of basic colors (for example, C/cyan; M/magenta; Y/yellow; and K/black). Further, the display layers 1c1-1cn have a thin display width for each color in relation to a length of the external periphery of the electronic pen, and the plurality of the display layers are aligned in the axis direction of the electronic pen by repeating the display layers of the basic colors RGB or CMYK.

The cross sectional structure when the display 1 according to the fourth embodiment is divided in a perpendicular direction in the figure is the same as FIG. 11A. The number of transparent electrodes 1et corresponds to the location of each color filter in the display area 1Md. In the wiring area 1Me, the conductive member 1p connects each of the transparent electrodes 1et corresponding to the same color filter to one another.

FIG. 12C is a schematic view of the clip member of the electronic pen P. The configuration of the clip 9 is integrated with the protective member 9a. The wiring area 1Me provided on the upper end portion of the display 1 attached to the electronic pen is fixed and protected by the pen case 1a and the protective member 9a of the clip member.

According to the fourth embodiment of the present invention, as described above, the area for drive wiring provided in the gap S of the display in the longitudinal direction of the electronic pen is no longer necessary. Therefore, it is possible to minimize the width of the gap S, which is only required as a connecting portion of both ends.

In the fourth embodiment, operations for the color and line type selections for the electronic pen are the same as the operation flow shown in FIG. 9 of the second embodiment.

### Fifth Embodiment

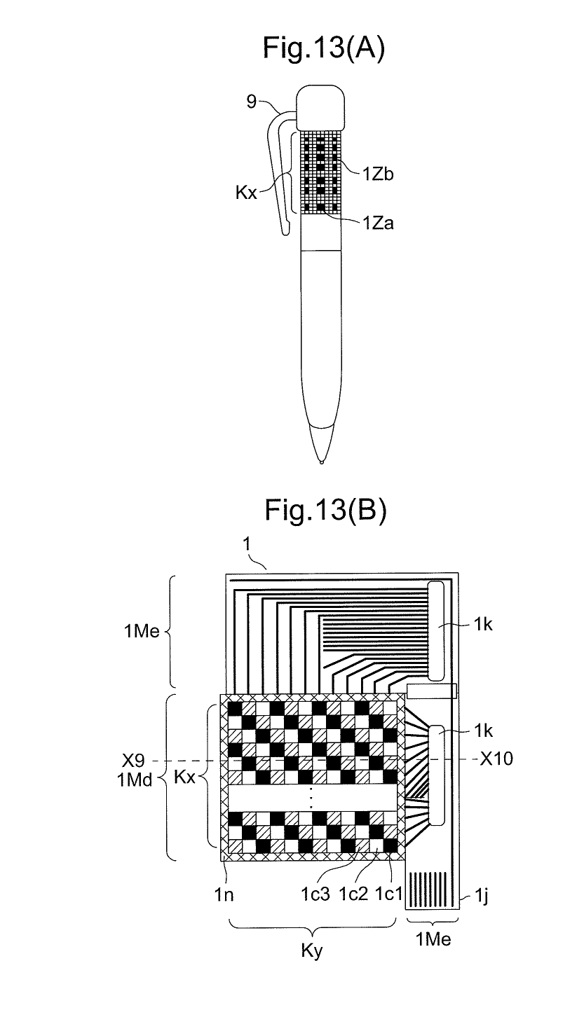

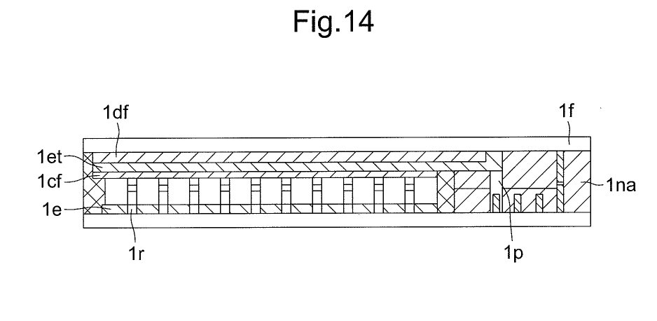

FIGS. 13A, 13B, 14, 15A, 15B, 15C, 16A, and 16B are used to illustrate a fifth embodiment of the present invention. FIGS. 13A and 13B illustrate a basic configuration of an electronic pen according to the fifth embodiment of the present invention. FIG. 14 is a cross sectional view of a display of the electronic pen according to the fifth embodiment of the present invention. The basic block diagram of the fifth embodiment is the same as the first embodiment, which is shown in FIG. 2. In FIGS. 13A, 13B and 14, structural elements similar to the first to the fourth embodiments are provided with the identical numerical references, and illustrations thereof are omitted.

FIG. 13A illustrates the display 1 of the electronic pen according to the fifth embodiment of the present invention. FIG. 13B is a schematic view of the electronic pen according to the fifth embodiment.

In FIG. 13A, the display 1 of the electronic pen P has a pen thickness display 1Za that displays the selected color of the electronic pen (red, for example) and the thickness of the character; and a line type display 1Zb that displays the selected line type (broken line, for example). The electronic pen according to the fifth embodiment can display desired color and pattern on the display 1 in which display cells configured with basic colors (RGB or CMYK) are aligned in matrix.

As shown in FIG. 13B, the display 1 is configured with a display area 1Md that is configured with a plurality of display cells; and an L-shaped wiring area 1Me that is connected to the display circuit 2. The display 1 has a display layer configured with Kx rows×Ky columns. The display layer has color filters including 3 basic colors (represented by R/red; G/green; and B/blue), or other plurality of basic colors (for example, C/cyan; M/magenta; Y/yellow; and K/black). The width and the length of each display cell is set smaller compared to the external periphery length of the electronic pen (for example, the width and the length of each display cell are 0.3 mm or less). By repeating the basic colors, the display cells are aligned in matrix.

In the fifth embodiment, as shown in the cross sectional view of the display 1 in FIG. 14, the plate-shaped common electrode for driving is not included. Instead, line-shaped electrodes for both surface layer film and base film so that the electrodes intersect orthogonally to one another, similar to the passive matrix driving. Kx rows are provided for the row driving electrodes for the transparent film side, corresponding to the color filters location of the display cell. Ky columns are provided for the column driving electrodes for the base film side. By selectively applying a voltage between the row driving electrodes and column driving electrodes, the reflective light amount in the display layer at the intersecting locations is controlled.

The wiring area 1Me includes a driver circuit 1k for driving the rows and columns. An output terminal of the driver circuit 1k is connected to the driving electrodes of the display 1. An input signal of the driver circuit k is connected through a wiring (not shown in the drawing) via the display circuit 2 and the connector 1j of the wiring area 1Me. The driver circuit 1k provided on the wiring area 1Me is provided in the gap S.

The driver circuit 1k is supplied with two different types of power voltages for driving. The driver circuit 1k receives a clock signal for synchronization and driving data for writing, which are supplied from the display circuit 2. Upon receiving the driving data in the number of the driving electrodes, the driver circuit 1k outputs 3 types of voltages to the driving electrodes based on the driving data and a driving timing signal.

For example, 3 types of voltages, +5V, 0V, and −5V, are output. Accordingly, for writing, +5V is applied to the row electrodes, and −5V applied to the column electrodes of the display layer. When the column electrodes are based, +10V is applied to the display layer. 0V state is kept for electrodes that do not need to be written.

Therefore, +5V or −5V is applied to display cells in the same row and in the same column that are not written. In other words, by decreasing the power voltage for driving smaller than the voltage for responding to the liquid crystals and the electrophoretic material configuring the display cells, it is possible to control the display operation.

Further, by applying −5V to the row electrodes and +5V to the column electrodes, i.e., by applying the reversible potentials, it is possible to change the display layer to its original state.

In the fifth embodiment, the driver circuit 1k is aligned in one row in the gap. However, the similar effect can be achieved by using a thin and flexible driver circuit 1k, positioned orthogonal to the axis of the electronic pen.

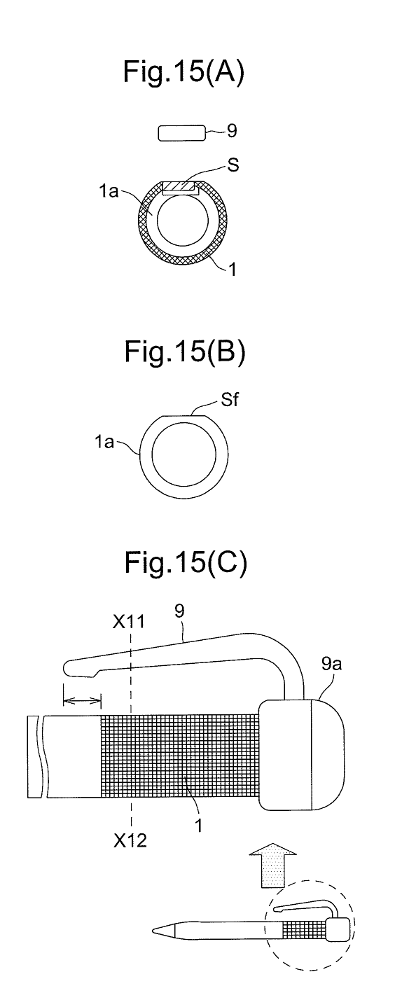

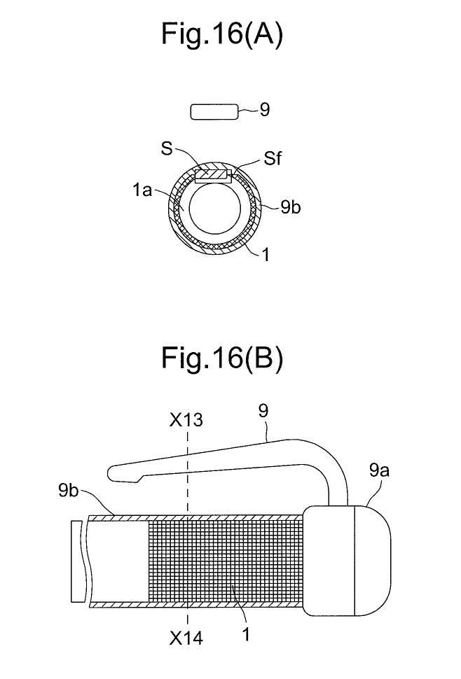

FIGS. 15A, 15B, 15C, 16A, and 16B are used to illustrate a configuration of the clip portion attached to the electronic pen P according to the fifth embodiment of the present invention.

FIGS. 15A-15C are schematic views of a clip portion and a gap portion of the electronic pen used in the fifth embodiment of the present invention. FIG. 15A is a cross sectional view of the display 1 and the clip 9 taken along broken line X11-X12 (see FIG. 15C). FIG. 15B is a cross sectional view of the pen case of the electronic pen P. FIG. 15C is an enlarged schematic view of the clip 9.

In FIG. 15B, the pen case 1a has a flat portion Sf along the longitudinal direction of the electronic pen. Further, as shown in FIG. 15A, the wiring area 1Me positioned in the gap S of the display 1 is overlapped by the flat portion Sf. The wiring area 1Me of the display 1, provided on the upper end opposing the pen point of the electronic pen P, is covered by the clip 9. Further, the clip 9 and the display 1 are fixed with the pen case 1a through the protective member 9a. The length of the clip 9, which is used to clip the pen on the user's clothes pocket and the like, is set longer than the length of the display 1.

FIGS. 16A and 16B illustrate other configurations of the clip. FIG. 16A is a cross sectional view of the display 1 and clip 9 taken along broke line X13-X14 (see FIG. 16B). FIG. 16B is an enlarged schematic view of the clip 9. In FIGS. 16A and 16B, a protective member 9b in the axial direction is added. The protective member 9b has a transparent cylindrical shape.

In FIG. 16A, the display 1 is attached by being matched to the flat portion Sf of the pen case 1a. When the connector 1j of the wiring area 1Me of the display 1 is connected to the display circuit 2 within the pen case, the protective member 9a is attached to the upper end of the pen case 1a. The protective member 9b is inserted into the electronic pen from the outside of the display 1, and fixed by the clip 9 and the protective member 9a.

Accordingly, by providing the clip portion, it is difficult for the user to see the gap S in the display 1, the gap S otherwise adversely affecting the design of the pen. Further, the wiring area that plays a key role in the display function can be protected from damages caused by external impacts and the like.

In the fifth embodiment illustrated above, the clip and the protective member 9a are separately configured. However, the similar effects can be achieved when the two are integrally configured, or configured into three or more separate parts, in order to simplify assembly.

Further, in the fifth embodiment illustrated above, the protective members 9a and 9b are separately configured. However, the protective members 9a and 9b may be integrally configured, or integrally formed including the clip 9. In addition, the shape of the protective member 9b is not limited to the cylindrical shape. The similar effects can be obtained with the protective member 9b having a circular arc opening in the cross section in relation to the axis, such as a semi-cylindrical shape for example. Further, instead of being entirely transparent, a portion may be colored or attached with a sticker, in order to protect and/or visually cover the gap.

Of course, the clip configuration shown in the fifth embodiment may be used for the first through the fourth embodiments. When used for the electronic pen P according to the second embodiment, a cylindrical hole may be provided for the switch 7 to the center of the end portion of the protective member 9a.

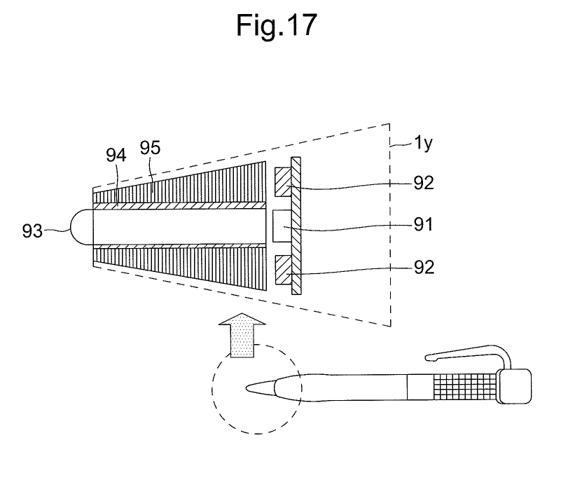

FIG. 17 is a cross sectional view of the pen point of the electronic pen according to the first through the fifth embodiments of the present invention. As shown in FIG. 2, the electronic pen P includes a light detector 8.

FIG. 17 is a cross sectional drawing illustrating the internal structure of a pen point holder 1y. The electronic pen P includes a light receiving sensor 91, one or more light sources 92, a receiving light guiding member 93, a light reflective film 94, and a light source directing member 95.

The light detector 8 includes the light receiving censor 91 and the light source 92. The light receiving censor 91 individually detects a light level in the different wave length ranges for R, G, B, and the like, and the light source 92 is configured with a white LED, or combined LED having different light wave lengths for R, G, and B. The light receiving censor 91 and the light source 92 may be provided on the same substrate.

The light receiving censor 91 may be configured with three light receiving elements having a wide detection range for wave lengths for the receiving light, the elements being provided with color filters to control transmitting wave lengths corresponding to the wave lengths of R, G, and B.

The pen point holder 1y includes the receiving light guiding member 93; the light source directing member 95; and the light reflective film 94. The receiving light guiding member 93 is configured with a translucent material, such as acrylic resin, polycarbonate resin, polystyrene resin, vinyl chloride resin, glass, or the like. In order to allow the receiving light guiding member 93 to have a lens effect, an extremity of a rod shaped member is processed to have a spherical shape.

The light reflecting film 94 is provided on the side surface periphery, excluding the spherical-shaped extremity and an end portion of the receiving light guiding member 93. The light reflecting film 94 is configured by evaporation-coating the surface of the receiving light guiding member 93 with a metal, such as aluminum or gold. Alternatively, the receiving light guiding member 93 may be coated with a hallow-processed cylindrical metal member, such as aluminum, in order to allow the receiving light guiding member 93 to have a light reflective function.

The light source directing member 95 has the receiving light guiding member 93 and the light reflective film 94, and is configured with a translucent material.

The light output from the light source 92 is directed into the light source directing member 95, is reflected by the inner surface of the case of the pen point holder 1y and by the light source directing member 95, and irradiates the outer portion of the electronic pen form the pen point side. When the pen point of the electronic pen is on a sheet of paper, light that irradiates the paper is reflected and enters the receiving light guiding member 93.

The light that has entered the receiving light guiding member 93 is reflected by the light reflecting film 94, passed through the inside of the receiving light guiding member 93, and supplied to the receiving light sensor 91. The light input from the pen point of the electronic pen is detected by the light detector 8, according to the level detected by the light receiving sensor 91.

Accordingly, since the light detector 8 is provided to the electronic pen P, the mode selection of the electronic pen can be set to a color detection mode (not shown in the drawing), so that the color of the location the user touched with the pen point of the electronic pen can be measured by the electronic pen.

When the user ends the color detection during the color selection mode of the electronic pen, and when the operation of the terminal apparatus T is during the pen input mode, the pressing of the electronic pen causes the communicator 6 to transmit, to the terminal apparatus T, data D6 that includes the pen property of the detected color; the status flag indicating change made by the electronic pen; and the pen ID, similar to step S46 shown in FIGS. 6 and 9. The terminal apparatus T stores color data in the pen property corresponding to the ID received from the electronic pen. When the electronic pen touches the display 10 of the terminal apparatus T and draws a line, the display 10 of the terminal apparatus T displays the color detected in the above-described procedure.

Accordingly, the user can display on the display 10 of the terminal apparatus T, a picture or drawing in a portion where a color palette is not displayed, and measure the color through the electronic pen. The user can also directly measure the color of an actual object surface, such as paper, outside of the terminal apparatus T. The user may select the color as the electronic pen property on the terminal apparatus T. Therefore, the electronic pen allows selection of intuitive color and density, not only the color and density on the color palette.

It is preferable that the internal surface of the case of the pen point holder 1y is white or formed with a light reflective film. Although not shown in the drawing, it is preferable to provide a covering member for shutting off light between the light receiving sensor 91 and the light source 92, so that the light from the light source 92 does not directly enter the light receiving sensor 91.

In addition, the receiving light guiding member 93 may be provided with a switch and a mechanism to activate the same, so that the color is detected when the pen point is pressed. Further, when detecting a color on a self-emitting display, such as the display 10 of the terminal apparatus T for example, the light source 92 may directly measure color of the output light, without emitting light. In other words, the light source is turned on after detecting insufficiency of the receiving light amount. Therefore, it is possible, measure both self-emitting colors and non self-emitting colors.

Since the electronic pen according to the present invention has the display that can display even when there is no electricity along the external periphery, the user can quickly identify the pen property, such as color set for the electronic pen. Through the use of the communicator, the electronic pen can share the pen property information with the terminal apparatus.

Accordingly, the present invention can be applied to an electronic pen as a writing tool easily used even by a young child. It can be applied to a usage where a teacher in a educational environment corrects a student's work on the terminal apparatus.

It is noted that the foregoing examples have been provided merely for the purpose of explanation and are in no way to be construed as limiting of the present invention. While the present invention has been described with reference to exemplary embodiments, it is understood that the words which have been used herein are words of description and illustration, rather than words of limitation. Changes may be made, within the purview of the appended claims, as presently stated and as amended, without departing from the scope and spirit of the present invention in its aspects. Although the present invention has been described herein with reference to particular structures, materials and embodiments, the present invention is not intended to be limited to the particulars disclosed herein; rather, the present invention extends to all functionally equivalent structures, methods and uses, such as are within the scope of the appended claims.

The present invention is not limited to the above described embodiments, and various variations and modifications may be possible without departing from the scope of the present invention.

What is claimed is:

1. An electronic pen electronically drawing lines on a terminal apparatus, the electronic pen comprising:
a display that displays a property of the electronic pen, the display being a piece of electronic paper and extending around an external periphery of the electronic pen;
a gap that is provided between both opposing ends of the display; and
a conductive member that is positioned in the gap and is connected to the display to supply signals to the display.

2. The electronic pen according to claim 1, comprising:
a clip that is positioned over the gap and holds the electronic pen on another object.

3. The electronic pen according to claim 1, comprising:
a protective member that covers the display and the conductive member.

4. The electronic pen according to claim 1, wherein the display is a piece of color electronic paper with color filters.

5. The electronic pen according to claim 1, comprising:
a property setter that sets the property of the electronic pen.

6. The electronic pen according to claim 1, wherein the property of the electronic pen is a color of lines drawn by the electronic pen.

7. The electronic pen according to claim 1, wherein the property of the electronic pen is a density of lines drawn by the electronic pen.

8. The electronic pen according to claim 1, wherein the property of the electronic pen is a thickness of lines drawn by the electronic pen.

9. The electronic pen according to claim 1, wherein the property of the electronic pen is a type of lines drawn by the electronic pen.

10. An electronic pen system comprising:
an electronic pen and a terminal apparatus on which the electronic pen electronically draws lines, wherein,
the electronic pen comprises:
a display that displays a property of the electronic pen, the display being a piece of electronic paper and extending around an external periphery of the electronic pen;
a gap that is provided between both opposing ends of the display; and
a conductive member that is positioned in the gap and is connected to the display to supply signals to the display.

11. The electronic pen system according to claim 10, wherein the electronic pen further comprises a clip that is positioned over the gap and holds the electronic pen on another object.

12. The electronic pen system according to claim 10, wherein the electronic pen further comprises a protective member that covers the display and the conductive member.

13. The electronic pen system according to claim 10, wherein the display is a piece of color electronic paper with color filters.

14. The electronic pen system according to claim 10, wherein the electronic pen further comprises a property setter that sets the property of the electronic pen.

15. The electronic pen system according to claim 10, wherein the property of the electronic pen is a color of lines drawn by the electronic pen.

16. The electronic pen system according to claim 10, wherein the property of the electronic pen is a density of lines drawn by the electronic pen.

17. The electronic pen system according to claim 10, wherein the property of the electronic pen is a width of lines drawn by the electronic pen.

18. The electronic pen system according to claim 10, wherein the property of the electronic pen is a type of lines drawn by the electronic pen.
